(19) United States
(12) Patent Application Publication
(10) Pub. No.: US 2009/0198656 A1
(43) Pub. Date: Aug. 6, 2009

(54) IPTV collecting content information from content providers, and method and system for providing IPTV with content information

(75) Inventors: Dae-Hyun Lee, Seoul (KR); Chun-Un Kang, Seoul (KR); Ki-Yong Kim, Seoul (KR); Chang-Nam Chu, Yongin-si (KR); Seung-Hyuk Yu, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/285,989

(22) Filed: Oct. 17, 2008

(30) Foreign Application Priority Data
Feb. 1, 2008 (KR) 10-2008-0010701

(51) Int. Cl. G06F 7/06; G06F 17/30; G06F 15/16

(52) U.S. Cl. 707/3; 707/102; 709/202; 707/E17.108; 707/E17.047

(57) ABSTRACT

An Internet Protocol Television (IPTV) which collects content information from content providers and a method and system for providing the IPTV with the content information are provided. The IPTV includes a connection unit which enables the IPTV to be connected to the Internet for data transmission or reception over the Internet, a content information collection unit which collects information about content created by IPTV content providers over the Internet, a content information processing unit which creates standard metadata by processing the collected content information, a storage unit which stores the standard metadata, and an output unit which displays the content information of at least one channel by using the standard metadata.

### CROSS-REFERENCE TO RELATED APPLICATION

This application claims priority from Korean Patent Application No. 10-2008-0010701 filed on Feb. 1, 2008 in the Korean Intellectual Property Office, the disclosure of which is incorporated herein by reference in its entirety.

### BACKGROUND OF THE INVENTION

1. Field of the Invention

Apparatus and methods consistent with the present invention relate to an Internet Protocol Television (IPTV) that collects content information from content providers and a method and system for providing the IPTV with the content information, and more particularly, to an IPTV that collects content information from content providers and a method and system for providing the IPTV with the collected content information.

2. Description of the Related Art

IPTV is a product for providing information services, moving picture contents, broadcast programs, and so forth through a television (TV) set using the Internet.

Since IPTV unites the Internet and TV, it can be called a type. of digital convergence. Connecting the TV with the Internet may be effected by providing a power supply to the TV. Thus, although a user is unfamiliar with a computer, the user is able to gain access to various content items and additional services offered via the Internet, such as Internet navigation, movie appreciation, home shopping, on-line games, and the like, through a TV screen.

IPTV is similar to general cable broadcasting or satellite broadcasting in that it provides broadcast contents including video, but is different in that it has interactivity. Unlike common over-the-air broadcasting, cable broadcasting, or satellite broadcasting, a user can select and enjoy desired content at a desired time, thereby increasing users' options.

Therefore, there is a need for a method and system for efficiently collecting content information from content providers and providing the collected content information to users using IPTVs.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

Exemplary embodiments of the present invention provide an IPTV which automatically collects content information from content providers.

Exemplary embodiments of the present invention also provide a method and system for automatically collecting content information from content providers and providing the collected content information to an IPTV.

Exemplary embodiments of the present invention also provide a method and system for collecting content information from various content providers and providing the collected content information to an IPTV by using standardized metadata.

According to an aspect of the present invention, there is provided an IPTV which collects content information from content providers, the IPTV including a connection unit which enables the IPTV to be connected to the Internet for data transmission or reception over the Internet, a content information collection unit which collects information about content created by an IPTV content provider over the Internet, a content information processing unit which creates standard metadata by processing the collected content information, a storage unit which stores the standard metadata, and an output unit which displays the content information of at least one channel by using the standard metadata.

According to another aspect of the present invention, there is provided a system for collecting content information from content providers and providing the content information to an IPTV. The system includes a content information collection unit which collects information about content created by an IPTV content provider, a content information processing unit which creates standard metadata by processing the collected content information, a storage unit which stores the standard metadata, and a content information providing unit which provides the content information of at least one channel to the IPTV by using the standard metadata.

According to still another aspect of the present invention, there is provided a method of collecting content information from content providers and providing the content information to an IPTV. The method includes collecting content information created by IPTV content providers, creating standard metadata by processing the content information, storing the standard metadata, and providing the content information of at least one channel to the IPTV by using the standard metadata.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of an IPTV which collects content information from content providers according to an exemplary embodiment of the present invention;

FIG. 2 is a block diagram of a system for collecting content information from content providers and providing the collected content information to an IPTV according to an exemplary embodiment of the present invention;

FIG. 3 illustrates an example in which content information is provided for each channel according to an exemplary embodiment of the present invention;

FIG. 4 illustrates a data structure of standard metadata used in the system for collecting content information from content providers and providing the collected content information to an IPTV according to an exemplary embodiment of the present invention;

FIG. 5 is a flowchart illustrating a method of collecting content information from content providers and providing the collected content information to an IPTV according to an exemplary embodiment of the present invention; and

FIG. 6 is a flowchart illustrating a method of viewing content on an IPTV by using collected content information according to an exemplary embodiment of the present invention.

### DETAILED DESCRIPTION OF EXEMPLARY EMBODIMENTS OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims and their legal equivalents.

An IPTV collecting content information from content providers, and a method and system for providing the IPTV with the content information according to exemplary embodiments of the present invention, will be described hereinafter with reference to flowchart illustrations of methods according to exemplary embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to create means for implementing the functions specified in the flowchart block or blocks. These computer program instructions may also be stored in a computer usable or computer-readable memory that can direct a computer or other programmable data processing apparatus to function in a particular manner, such that the instructions implement the function specified in the flowchart block or blocks. The computer program instructions may also be loaded onto a computer or other programmable data processing apparatus to cause a series of operational steps to be performed on the computer or other programmable apparatus to produce a computer implemented process for implementing the functions specified in the flowchart block or blocks.

In addition, each block may represent a module, a segment, or a portion of code, which may comprise one or more executable instructions for implementing the specified logical functions. It should also be noted that in other implementations, the functions noted in the blocks may occur out of the order noted or in different configurations of hardware and software. For example, two blocks shown in succession may, in fact, be executed substantially concurrently, or the blocks may sometimes be executed in the reverse order, depending on the functionality involved.

Meanwhile, the term ‘unit’, as used herein, means, but is not limited to, a software or hardware component, such as a Field Programmable Gate Array (FPGA) or Application Specific Integrated Circuit (ASIC), which performs certain tasks. A unit may advantageously be configured to reside on the addressable storage medium and configured to execute on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or further separated into additional components and units. In addition, the components and units may be implemented such that they execute one or more computers in a communication system.

Hereinafter, the present invention will be explained in more detail with reference to the accompanying drawings in which exemplary embodiments of the invention are shown.

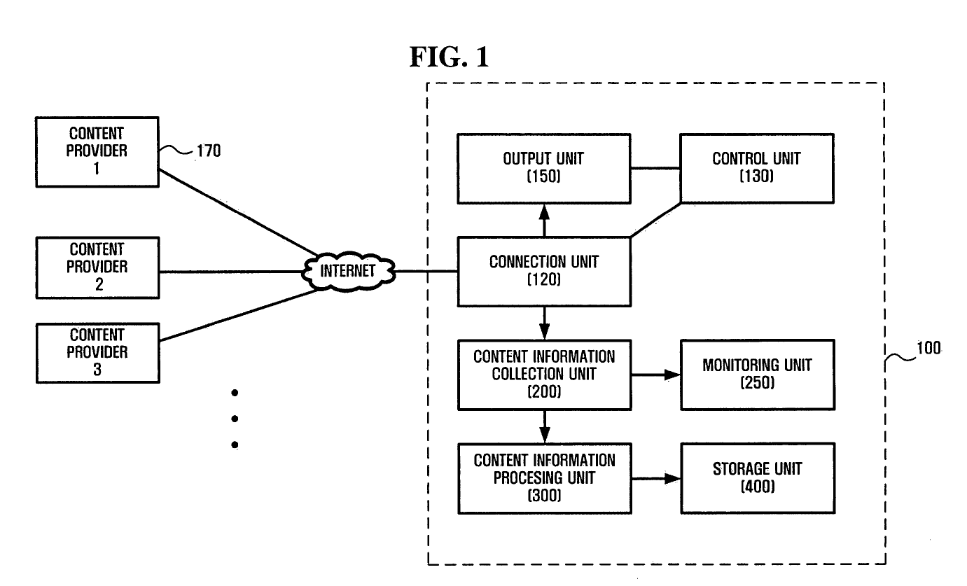

FIG. 1 is a block diagram of an IPTV which collects content information from content providers according to an exemplary embodiment of the present invention.

Referring to FIG. 1, an IPTV 100 collecting content information from content providers according to an exemplary embodiment of the present invention includes an output unit 150, a connection unit 120, a content information collection unit 200, a content information processing unit 300, a storage unit 400, a monitoring unit 250, and a control unit 130.

The output unit 150 displays information on the IPTV 100. The output unit 150 includes not only a common display, such as a Cathode Ray Tube (CRT), a Liquid Crystal Display (LCD), a Plasma Display Panel (PDP), an Organic Light Emitting Diode (OLED), or an Electro Chromic Display (ECD), but also a display unit for visually outputting on a screen, data that has been created for information delivery to a user. The output unit 150 basically displays details of content at the time of playing the content on the IPTV 100, but may arrange content information provided from content providers for each channel and provide the content information of each channel to a user.

The connection unit 120 enables the IPTV 100 to be connected to the Internet for data transmission or reception over the Internet. The connection unit 120 transforms data received from an external source through the Internet in order to output the data to the output unit 150 of the IPTV 100. For example, when the connection unit 120 is a set-top box, the set-top box not only serves as a terminal for connecting the IPTV 100 to the Internet, but also transforms content obtained through the Internet into IPTV content and provides the IPTV content to the output unit 150.

The control unit 130 controls components of the IPTV 100 such as the output unit 150 and the connection unit 120. The control unit 130 may control delay time and buffering in the output unit 150 according to the bandwidth of an Internet line and the quality of content provided in the IPTV 100. The control unit 130 may adjust operations of the output unit 150 and the connection unit 120 of the IPTV 100 according to a user's remote input or an external input.

The content information collection unit 200 may collect content information from various content providers 170. The content information collection unit 200 may extract metadata such as web sites, content, and content maps of the content providers 170 over the Internet in order to collect the content information. The content information is brief information of content that can be extracted from metadata. For example, the content information may include direction information about content, such as the name, category, type, and creation date of the content, and indirection information about the content required for the use of the content, such as the storage position, copyright, and authentication and billing of the content, the number of available simultaneous accesses to the content, and the validity of the content.

The content information collection unit 200 may periodically extract metadata from web sites, content, and content maps of the content providers 170 by using a crawler or a collecting robot in order to collect the content information. Herein, the web sites, the content, and the content maps of the content providers 170 may be previously defined or continuously updated by the crawler, or may be previously defined in IPTV service maps provided by the content providers 170.

The content information processing unit 300 generates standardized content information by processing the collected content information. The content information processing unit 300 standardizes the content information by using a metadata filter. The content information processing unit 300 may obtain content information of various content items provided from various content providers and generate standard metadata having a single standardized data structure. This is because content information of various content items cannot be structurally provided to users as long as the content information is not standardized. Thus, standard metadata having a standardized data structure is generated from content information of various content items extracted from a wide range of sources. The standard metadata may include direct information about the content and indirect information about the content.

The content information processing unit 300 may divide the standard metadata for each channel. Herein, a “channel” means a TV channel used in the IPTV 100. However, unlike over-the-air channels or cable channels, channels in the IPTV 100 can be roughly divided based on a predetermined criterion such as category, theme, and details according to the user's designation or the system's setting. Thus, by dividing the standard metadata for each channel, a user can change a channel in the IPTV 100, and thus can see content information that have been roughly divided based on a predetermined criterion such as category, theme, and details.

The monitoring unit 250 accesses predetermined content based on the standard metadata in order to determine whether the predetermined content can be serviced. In addition, the monitoring unit 250 periodically accesses each content item for stable servicing of each content item, and notifies the content information collection unit 200 or the content information processing unit 300 of the deletion or shift of each content item if the content is deleted or shifted. Further, in an exemplary embodiment, the monitoring unit 250 periodically monitors the availability of each of the content items stored in servers of the content providers 170 using the standard metadata. The monitoring unit 250 separately accesses each content item in order to check if the content is duplicated. The monitoring unit 250 may monitor the duplicity of each content item by checking whether there are at least two content items that are identical, or collectively using the content data, including position, file size, file name, and so on of each content item.

The storing unit 400 stores standard metadata obtained by standardizing content information of various content items. When a user turns on the IPTV 100 or desires to access content provided by content providers through the IPTV 100, the control unit 130 may provide content information to the output unit 150 by using standard metadata stored in the storage unit 400. By displaying the standard metadata stored in the storage unit 400 for each channel when a user changes a channel in the IPTV 100, content information can be displayed based on category, theme, and details.

As such, according to an exemplary embodiment of the present invention, information about various content items provided by content providers are previously collected and displayed in the IPTV 100, thereby efficiently displaying content information that can be serviced by the IPTV 100 at a user's desired time.

In addition, by standardizing content information of various content items from various content providers and processing the content information as standardized metadata, the content information may be arranged for each channel based on category, theme, and details, thereby satisfying various users' demands.

Moreover, each content item of each content provider is periodically monitored to allow each content item to be provided in a stable manner, thereby preventing service outage caused by deletion or shift of the content.

Furthermore, users can obtain accessible content information on their IPTV screens without separately accessing portal sites or homepages of content providers.

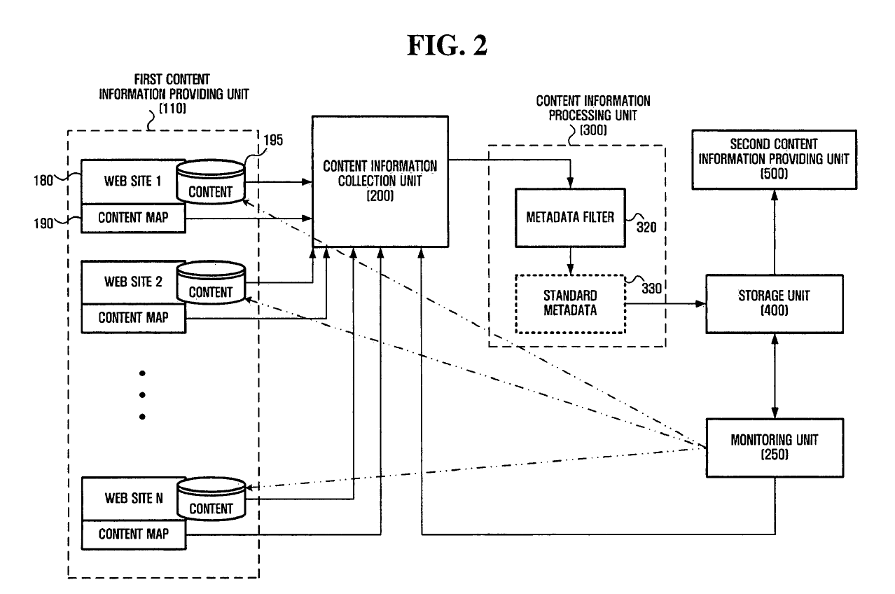

FIG. 2 is a block diagram of a system for collecting content information from content providers and providing the collected content information to an IPTV according to an exemplary embodiment of the present invention.

Referring to FIG. 2, a system for collecting content information from content providers and providing the collected content information to an IPTV according to an exemplary embodiment of the present invention includes a first content information providing unit 110, a content information collection unit 200, a content information processing unit 300, a storage unit 400, a second content information providing unit 500, and a monitoring unit 250.

The first content information providing unit 110 provides content information of content providers. The content providers generally provide information regarding contents available from them using their own web sites 180 or content maps 190 for publicity purposes. The content 195 may include metadata for describing media files. Thus, the first content information providing unit 110 may provide the web sites 180, the web pages, the content maps 190, or the metadata of the content 195 which are created by the content providers.

The content information collection unit 200 collects information regarding contents created by various content providers. For example, the content information collection unit 200 periodically visits the content maps 190 created by the content providers in order to collect information regarding content, including types, update dates, details, and the like. Alternatively, the content information collection unit 200 may directly access content files provided by the content providers and classify details, characters, and types of the content in order to collect the classification results as the content information or collect metadata of the content files as the content information.

Still alternatively, the content information collection unit 200 may access the web sites 180 of the content providers in order to collect information disclosed on the web sites 180, or visit linked web sites in order to collect related information.

As such, the content information collection unit 200 may collect the content information from web sites or content storage places of the content providers connected over the Internet, and such a collecting operation may be performed by a crawler, a search robot, or a spider.

The content information processing unit 300 may create a data structure by processing the collected content information. The content information processing unit 300 collects the content information about various content items and creates standard metadata 330 by applying a metadata filter 320 to metadata. Thus, the metadata filter 320 reads the content information about various content items in order to create the standard metadata 330 expressed by defining a standardized data structure. The standard metadata 330 may be defined in order to classify the content information based on any one of category, theme, and keyword, and the content information may be listed on the output unit 150 for each channel of an IPTV according to the classification results.

The storage unit 400 stores the created standard metadata 330. The storage unit 400 may display and store the content information to be provided to the IPTV as the standard metadata 330.

The second content information providing unit 500 obtains the standard metadata 330 stored in the storage unit 400 in order to provide the obtained standard metadata 330 to the IPTV or another object which requires the metadata. The content information providing unit 500 may provide the content information arranged for each channel to users who request the content information.

The monitoring unit 250 separately accesses each content item based on the obtained content information in order to periodically determine whether each content item is accessible in a current state. Thus, if the monitoring unit 250 determines that each content item is not accessible based on the standard metadata stored in the storage unit 400, or determines that corresponding content stored in that position is not accessible because of deletion or shift of the corresponding content, the monitoring unit 250 may notify the storing unit 400 or the content information collection unit 200 of the determination. The content information collection unit 200 may re-collect content information or the storage unit 400 may remove standard metadata for corresponding content. The monitoring unit 250 accesses each content item in order to check if each content item is duplicated. The monitoring unit 250 may monitor the duplicity of each content item by checking whether there are at least two content items that are identical, or collectively using the content data, including position, file size, file name, and so on of each content item. In this way, according to an exemplary embodiment of the present invention, content information is collected from various content providers and is arranged by using a standardized structure, thereby efficiently providing content information to users that access content through an IPTV. Moreover, content information and accessing the content can be provided in a stable manner by periodically accessing content to determine accessibility of the content.

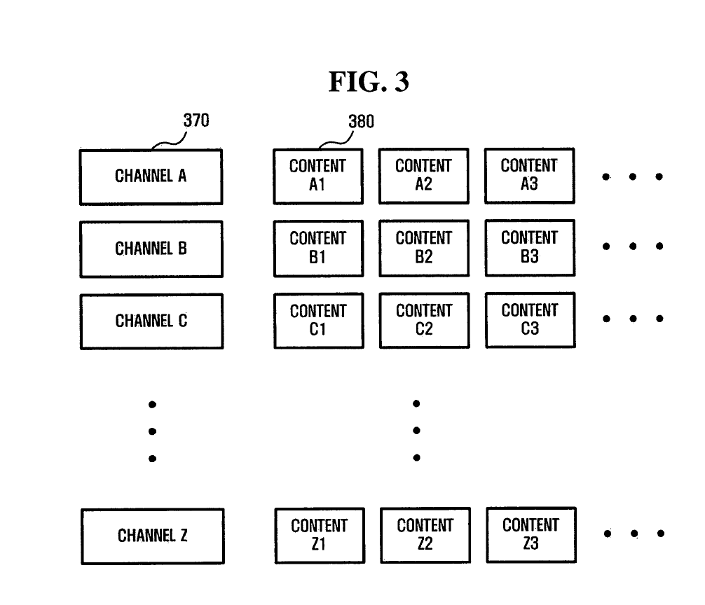

FIG. 3 illustrates an example in which content information is provided for each channel according to an exemplary embodiment of the present invention. Referring to FIG. 3, content information 380 may be structuralized from standard metadata and arranged for each channel. Herein, channels 370 indicate channels selected by a user in an IPTV and may include channels A-Z. A channel may indicate a type that can be classified based on a classification criterion such as category, content type, or content details identified by one data field of standard metadata.

When a user changes a channel, the content information 380 for content corresponding to each channel 370 may be listed. For example, if a channel is classified based on content type, the channel A may be classified as music, the channel B may be classified as moving picture, and the channel C may be classified as text. If a channel is classified based on theme, the channel A may be classified as ‘for children’, the channel B may be classified as ‘news’, the channel C may be classified as ‘drama’, the channel D may be classified as ‘movie’, the channel E may be classified as ‘music’, and the channel F may be classified as ‘for fishing’. Thus, by setting the channel classification criterion by a user or a system for collecting content information from content providers and providing the collected content information to an IPTV according to an exemplary embodiment of the present invention, the user can view information about content that is previously classified for each channel through the IPTV.

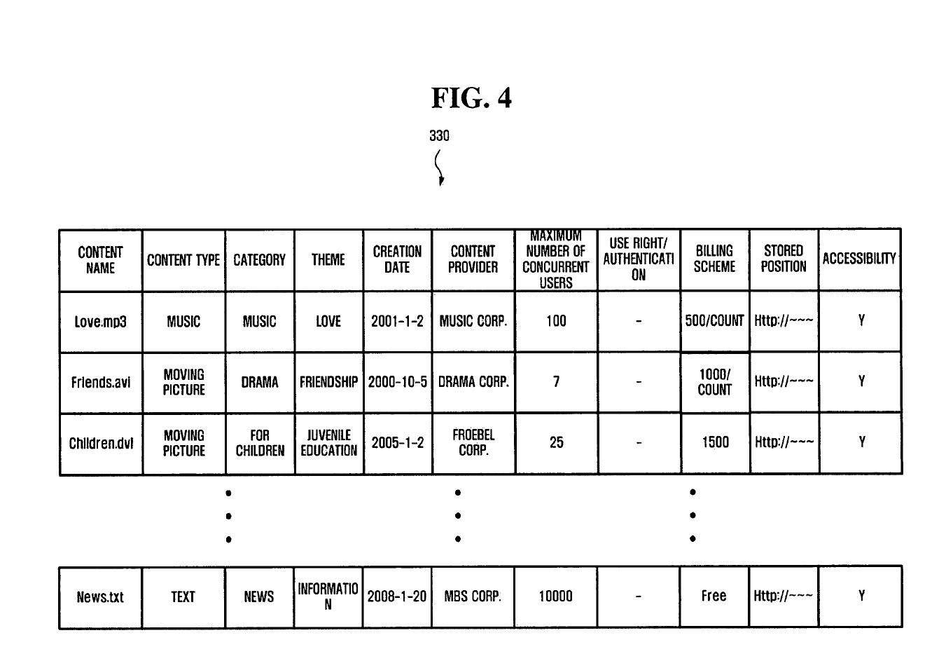

FIG. 4 illustrates a data structure of standard metadata used in the system for collecting content information from content providers and providing the collected content information to an IPTV according to an exemplary embodiment of the present invention.

Referring to FIG. 4, the standard metadata 330 may have a standardized data structure. For example, the standardized data structure may be composed of data fields, including content name, content type, category, theme, creation date, content provider, maximum number of concurrent users, use right/authentication, billing scheme, stored position, and accessibility. However, the standard metadata 330 may have various data structures capable of structurally expressing content information without being limited to the above example.

The data information processing unit 300 may extract information required for the data structure of the standard metadata 330 from content information collected from content providers by using the metadata filter 320. Thus, the metadata filter 320 may include a module capable of interpreting metadata of various types or a module capable of classifying various text information based on construction in order to extract information.

Thus, information about content required by data fields of standard metadata can be standardized from the content information collected by using the metadata filter 320.

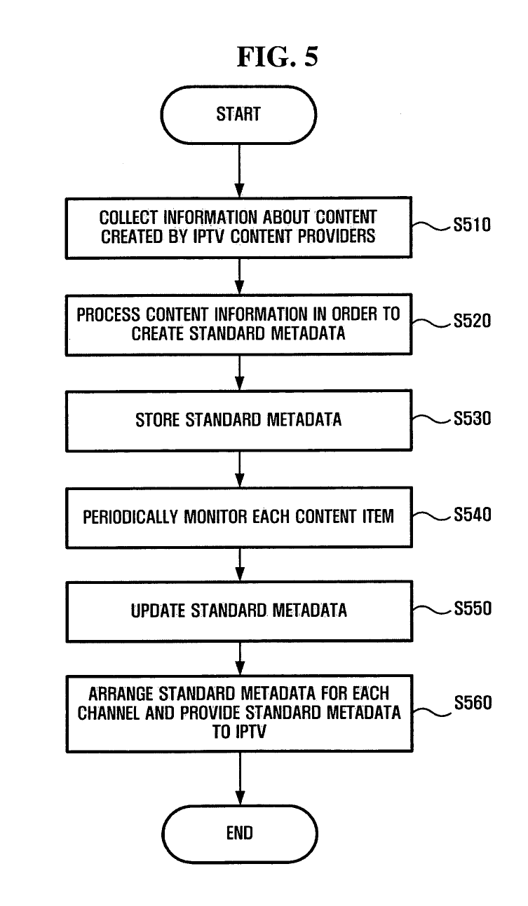

FIG. 5 is a flowchart illustrating a method of collecting content information from content providers and providing the collected content information to an IPTV according to an exemplary embodiment of the present invention.

Referring to FIG. 5, information about content created by IPTV content providers is collected in operation S510. The content information may be collected from web sites, web pages, content maps, and content metadata provided by various content providers. Collection of the content information may be performed by a crawler, a spider, or a search robot which automatically collects information over the Internet.

The collected content information is processed to create standard metadata in operation S520. Herein, the standard metadata is metadata obtained by standardizing a data structure for standardized expression of content information. Thus, by unifying content information collected in various forms into a single standardized structure, various content items can be efficiently structuralized.

Upon creation of the standard metadata, the created standard metadata is stored in a storage unit in operation S530. Each content item is periodically accessed based on the standard metadata in order to monitor availability of each content item in operation S540. This is because the speed of accessing each content item may not be lowered due to a content provider's frequent deletion, update, or shift of the content. Accordingly, duplicity of each content item may also be monitored.

The standard metadata may be periodically or non-periodically updated in operation S550. Collection of the content information may be continuously performed by a crawler, or existing standard metadata may be updated by processing continuously processed information and creating new standard metadata. Moreover, corresponding standard metadata may be updated according to the availability of each content item as determined by monitoring.

In operation S560, the standard metadata is provided to an IPTV. The provided standard metadata may be arranged for each channel in order to structurally output the standard metadata to an output unit of an IPTV.

As such, by previously collecting and standardizing information about content provided by various content providers, a user can easily access the content. Moreover, availability of content is periodically checked in order to secure stability when a user accesses the content.

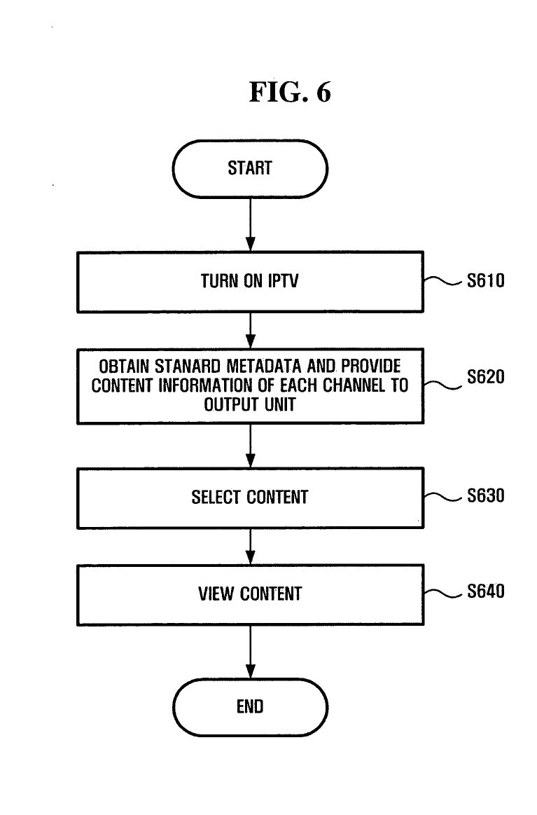

FIG. 6 is a flowchart illustrating a method of viewing content on an IPTV by using collected content information according to an exemplary embodiment of the present invention.

Referring to FIG. 6, a user turns on an IPTV in operation S610. Once the IPTV is turned on, the IPTV may be connected to the Internet through a connection unit.

Upon being turned on, the IPTV obtains standard metadata stored in the storage unit 400 or standard metadata stored in an external system such as an IPTV portal site and provides the standard metadata to a user in operation S620. At this time, the IPTV may structuralize the standard metadata for each channel as illustrated in FIG. 3 to provide information about content to the user.

The user changes a channel or views a description of each content item in a single channel for content selection in operation S630. Upon selecting particular content, the user may access a server (not shown) of a content provider that provides the selected content and view the selected content.

As such, by structuralizing previously stored content information before providing the content information to a user, the user can easily select and view desired content. Moreover, the user can recognize information of each content item allocated for each channel and directly access desired content without cumbersomely searching for the desired content.

As described above, according to an exemplary embodiment of the present invention, it is possible to provide an IPTV capable of automatically collecting content information from content providers and processing the collected content information by means of an information collection unit.

Moreover, various automatically-collected content information can be processed and stored as a standardized data structure and then be provided to the IPTV.

Furthermore, by collecting content information from various content providers and processing the content information as standardized metadata, updating and accessing the content information can be performed efficiently.

While the present invention has been particularly shown and described with reference to exemplary embodiments thereof, it will be understood by those of ordinary skill in the art that various changes in form and details may be made therein without departing from the spirit and scope of the present invention as defined by the following claims and their legal equivalents. It is therefore desired that the present exemplary embodiments be considered in all respects as illustrative and not restrictive, reference being made to the appended claims rather than the foregoing description to indicate the scope of the invention.

What is claimed is:

1. An Internet Protocol Television (IPTV) which collects content information from content providers, the IPTV comprising:
a connection unit which connects the IPTV to the Internet for data transmission or reception over the Internet;
a content information collection unit which collects content information about content created by IPTV content providers over the Internet;
a content information processing unit which creates standard metadata by processing the collected content information;
a storage unit which stores the standard metadata; and
an output unit which displays content information of at least one channel using the standard metadata.

2. The IPTV of claim 1, further comprising a monitoring unit which periodically monitors availability of each of content items stored in servers of the IPTV content providers by using the standard metadata.

3. The IPTV of claim 2, wherein the monitoring unit checks if each of content items is duplicated by checking whether at least two of the content items are identical or by using a position, a file size, and a file name of each of content items.

4. The IPTV of claim 1, wherein the content information collection unit collects the content information from at least one of web sites, content maps, and content metadata of the IPTV content providers.

5. The IPTV of claim 1, wherein the content information collection unit collects the content information from content web sites defined in content maps.

6. The IPTV of claim 1, wherein the content information processing unit extracts information required for a standardized data structure and creates the standard metadata by using a metadata filter.

7. The IPTV of claim 1, wherein the content information processing unit classifies in a classification, the content information based on one of classification criteria including category, theme, and keyword, and the output unit displays the content information of the at least one channel according to the classification performed based on the one of classification criteria.

8. A system for collecting content information from content providers and providing the content information to an Internet Protocol Television (IPTV), the system comprising:
a content information collection unit which collects content information about content created by IPTV content providers;
a content information processing unit which creates standard metadata by processing the collected content information;
a storage unit which stores the standard metadata; and
a content information providing unit which provides the content information of at least one channel to the IPTV by using the standard metadata.

9. The system of claim 8, wherein the content information processing unit extracts information required for a standardized data structure in order to create the standard metadata by using a metadata filter.

10. The system of claim 8, wherein the content information processing unit classifies in a classification, and lists the content information based on one of classification criteria including category, theme, and keyword, and the content information providing unit provides the content information of each channel according to the classification performed based on the one of classification criteria.

11. The system of claim 8, further comprising a monitoring unit which periodically monitors availability of each of content items stored in servers of the IPTV content providers by using the standard metadata.

12. A method of collecting content information from content providers and providing the content information to an Internet Protocol Television (IPTV), the method comprising:
collecting content information created by IPTV content providers;
creating standard metadata by processing the content information;
storing the standard metadata; and
providing the content information of at least one channel to the IPTV by using the standard metadata.

13. The method of claim 12, wherein the collecting of the content information comprises collecting the content information from at least one of web sites, content maps, and content metadata of the IPTV content providers.

14. The method of claim 12, wherein the collecting of the content information comprises collecting the content information from content web sites defined in content maps.

15. The method of claim 12, wherein the creating of the standard metadata comprises extracting information required for a standardized data structure and creating the standard metadata by using a metadata filter.

16. The method of claim 12, wherein the providing of the content information comprises classifying in a classification, and listing the content information based on one of classification criteria including category, theme, and keyword, and providing the content information of at least one channel according to the classification performed based on the one of classification criteria.

17. The method of claim 12, further comprising periodically monitoring availability of each of content items stored in servers of the IPTV content providers by using the standard metadata.

18. The method of claim 17, wherein the monitoring of the availability comprises checking if each of content items is duplicated by checking whether at least two of the content items are identical or by using a position, a file size, and a file name of each of content items.

19. The method of claim 17, further comprising updating the standard metadata according to the availability of each content item.
